(19) United States
(12) Patent Application Publication
(10) Pub. No.: US 2025/0076589 A1
(43) Pub. Date: Mar. 6, 2025

(54) VERY SMALL FORM FACTOR FIBER OPTIC CONNECTOR AND ADAPTER

(71) Applicant: Senko Advanced Components, Inc., Hudson, MA (US)

(72) Inventors: Wing Chiu HO, Kowloon (HK); Chi Ho FAN, Kowloon (HK); Kenji IIZUMI, Tokyo (JP); Kazuyoshi TAKANO, Tokyo (JP)

(21) Appl. No.: 18/825,449

(22) Filed: Sep. 5, 2024

Related U.S. Application Data
(60) Provisional application No. 63/580,640, filed on Sep. 5, 2023.

(51) Int. Cl. G02B 6/38

(52) U.S. Cl. CPC G02B 6/3883; G02B 6/3885

(57) ABSTRACT

A very small form factor multifiber fiber optic connection system includes an adapter and mating connectors with complementary prealignment features for prealigning multifiber ferrules in the adapter to prevent guide pin stubbing. The adapter has a prealignment feature formed on at least one interior side of each individual connector port and the connectors have a complementary prealignment formation along a side wall of the connector housing assembly. Each prealignment feature slidably engages the prealignment formation of a fiber optic connector as the fiber optic connector is inserted into the individual connector port to prealign a multifiber ferrule of the fiber optic connector in the adapter.

### CROSS-REFERENCE TO RELATED APPLICATION

This application claims priority to U.S. Provisional Patent Application No. 63/580,640, which is hereby incorporated by reference in its entirety.

### FIELD

This disclosure generally pertains to a fiber optic connection system for making multifiber optical connections.

### BACKGROUND

MPO-style connectors and adapters are widely used multifiber interconnects. Recently, there has been demand for multifiber interconnects that can achieve greater fiber densities than is possible with MPO-style connectors and adapters. Very small form factor (VSFF) multifiber interconnect components such as the SN-MT components (available from the assignee of the present disclosure) and MMC components (available from US Conec Ltd of Hickory, North Carolina) were developed to meet this need.

Like MPO-style connectors, VSFF multifiber connectors use multifiber mechanical transfer (MT) ferrules to precisely align multiple fibers at once and thereby make multifiber connections. An MT ferrule comprises two guide pin openings spaced apart along a fiber alignment axis of the ferrule. An MT ferrule can have a female configuration, where both guide pin openings are empty; a male configuration, where a guide pin is retained in each guide pin opening; or a hermaphroditic configuration, where one of the guide pin openings is empty and a guide pin is retained in the other guide pin opening. To make a multifiber connection, two MT ferrules are pressed together end-to-end so that two guide pins mate with two empty guide pin openings. The guide pins mating with the empty guide pin openings is what is ultimately controls optical alignment of the fibers contained in the two opposing ferrules.

While the guide pins and guide pin openings are the precision structures responsible for aligning the fibers contained in the two ferrules, it is important also to prealign the MT ferrules so that the guide pins accurately mate with the empty guide pin openings. Without precise prealignment of the ferrules, the guide pins may not properly center on the empty guide pin openings. In this case, the guide pins will impact (“stub”) the end face of the opposing ferrule. If stubbing occurs, it can damage the ferrule end face, leading to degraded optical performance.

### SUMMARY

In one aspect, a fiber optic connector comprises a multifiber ferrule having a fiber alignment axis and first and second guide pin openings spaced apart along the fiber alignment axis. A front body holds the multifiber ferrule. The front body has a height extending parallel to the fiber alignment axis and first and second side walls extending heightwise on opposite sides of the multifiber ferrule. The front body comprises a prealignment formation on at least the first side wall. An outer housing surrounds the front body. The outer housing comprises first and second side walls extending heightwise on opposite sides of the front body. At least the first side wall of the outer housing defines a cutout exposing the prealignment formation on the first side wall of the front body. The fiber optic connector is configured to be inserted into a mating receptacle, and the prealignment formation on at least the first side wall of the front body is configured to slidably engage a prealignment feature on a wall of the mating receptacle as the fiber optic connector is inserted into the mating receptacle to prealign the multifiber ferrule of the fiber optic connector along the fiber optic alignment axis in relation to said another multifiber ferrule for making a multifiber optical connection between the multifiber ferrule of the fiber optic connector and said another multifiber ferrule.

In another aspect, a fiber optic adapter comprises an adapter housing having a first end portion, a second end portion, a top wall, a bottom wall, a first side wall, a second side wall, a length extending from the first end portion to the second end portion, a height extending from the top wall to the bottom wall, and a width extending from the first side wall to the second side wall. The adapter housing defines a first receptacle adjacent the first end and a second receptacle adjacent to the second end portion. The first and second receptacles meet at an optical reference plane spaced apart lengthwise between the first end portion and the second end portion. At least one partition wall is in the first receptacle. The at least one partition wall subdivides the first receptacle into a plurality of individual connector ports. The individual connector ports are spaced apart widthwise along the first receptacle. The first side wall, the second side wall, and the at least one partition wall define first and second interior sides of each of the individual connector ports. A prealignment feature is formed on at least the first interior side of each of the connector ports. Each prealignment feature is configured to slidably engage a prealignment formation on a first side of a fiber optic connector as the fiber optic connector is inserted into the individual connector port to prealign a multifiber ferrule of the fiber optic connector in the adapter.

In another aspect, a fiber optic connector comprises a connector housing assembly having a top portion, a bottom portion, a first side wall, a second side wall, a height extending from the bottom portion to the top portion, and a width extending from the first side wall to the second side wall. The height is at least double the width. A multifiber ferrule has a fiber alignment axis and first and second guide pin openings spaced apart along the fiber alignment axis. The multifiber ferrule is received in the connector housing assembly such that the fiber alignment axis extends heightwise. A prealignment groove is formed in the first side wall and the second side wall of the connector housing assembly. Each prealignment groove has an open front end into which a prealignment projection on an interior side of a mating adapter is passable as the fiber optic connector is plugged into the mating adapter, whereby the side wall of the connector housing assembly engages with the prealignment projection to prealign the multifiber ferrule with the mating adapter for making an optical connection to another multifiber ferrule in the mating adapter without guide pin stubbing.

Other aspects will be in part apparent and in part pointed out hereinafter.

### BRIEF DESCRIPTION OF THE DRAWINGS

FIG. 1 is a perspective of a VSFF connection system in accordance with the present disclosure including an adapter, a connector, and a behind-the-wall connector;

FIG. 2 is a perspective of the adapter;

FIG. 3 is an elevation of the adapter;

FIG. 4 is a cross-sectional perspective of the adapter;

FIG. 5 is a cross section of the adapter;

FIG. 6 is an elevation of the connector;

FIG. 7 is a perspective of the connector;

FIG. 7A is an enlarged view of a portion of FIG. 7;

FIG. 8 is an elevation of the connector;

FIG. 9 is an elevation of a subassembly of the connector missing an outer housing of the connector;

FIG. 10 is a perspective of the subassembly;

FIG. 11 is an elevation of the subassembly;

FIG. 12 is an enlarged fragmentary perspective of the subassembly;

FIG. 13 is an enlarged fragmentary elevation of the subassembly;

FIG. 14 is a perspective of the behind-the-wall connector;

FIG. 15 is an elevation of the behind-the-wall connector;

FIG. 16 is an elevation of the behind-the-wall connector;

FIG. 17 is a fragmentary perspective showing the connector approaching an individual connector port of the adapter;

FIG. 18 is a fragmentary cross section showing the connector being inserted into the connector port;

FIG. 19 is a fragmentary cross section showing a prealignment feature of the adapter engaging a prealignment formation of the connector to prealign the connector in the adapter;

FIG. 20 is a fragmentary cross section showing the connector mated with the adapter and the behind-the-wall connector being inserted;

FIG. 21 is another fragmentary cross section similar to FIG. 20;

FIG. 22 is another fragmentary cross section similar to FIG. 20 but taken in a different cross-sectional plane;

FIG. 23 is another fragmentary cross section similar to FIG. 20 but showing the behind-the-wall connector mated with the adapter;

FIG. 24 is another fragmentary cross section similar to FIG. 23 but taken in a different cross-sectional plane;

FIG. 25 is another fragmentary cross section similar to FIG. 24;

FIG. 26 is a fragmentary cross section showing two of the connectors of FIGS. 6-8 in the adapter;

FIG. 27 is another fragmentary cross section similar to FIG. 26 but taken in a different cross-sectional plane;

FIG. 28 is a perspective of another adapter;

FIG. 29 is a perspective of another connector configured for mating with the adapter of FIG. 28;

FIG. 30 is a fragmentary cross section showing the connector of FIG. 29 being inserted into the adapter of FIG. 28;

FIG. 31 is a fragmentary cross section showing a prealignment feature of the adapter of FIG. 28 engaging a prealignment formation of the connector of FIG. 29 to prealign the connector in the adapter; and

FIG. 32 is a fragmentary cross-sectional perspective showing the connector and adapter as seen in FIG. 31.

Corresponding parts are given corresponding reference characters throughout the drawings.

### DETAILED DESCRIPTION

This disclosure generally pertains to very small form factor (VSFF) fiber optic components. Certain aspects of this disclosure pertain to fiber optic connectors, including, full-feature fiber optic connectors of the type that are typically installed in front of the wall of fiber optic equipment, where the connectors are normally accessible to human users of the equipment. Other aspects of this disclosure pertain to so-called “behind-the-wall” connectors, which typically terminate non-jacketed optical fibers (e.g., optical fiber ribbons) and are typically shorter in length than their full-featured counterparts. Other aspects of this disclosure pertain to fiber optic receptacles of the type that mate with fiber optic connectors. Additionally, this disclosure pertains to fiber optic connection systems encompassing a fiber optic receptacle in combination with one or more mating connectors.

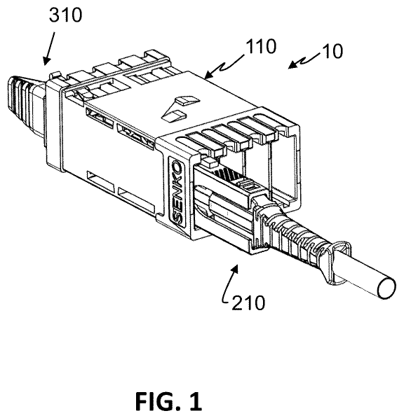

Referring to FIG. 1, an exemplary fiber optic connection system in accordance with the present disclosure is generally indicated at reference number 10. The illustrated connection system 10 comprises an adapter 110, one or more full-featured connectors 210, and one or more behind the wall connectors 310. Other connection systems in the scope of the present disclosure may utilize a different combination of components (e.g., an adapter that mates with only full-featured connectors, an optical transceiver receptacle that mates with full-featured connectors or behind-the-wall connectors, etc.)

The fiber optic connection system 10 is an SN-MT connection system of the type that is being offered for sale in the United States by the assignee of the present disclosure. The SN-MT connection system encompasses VSFF components equipped for making multifiber optical connections. That is, the connection system 10 is broadly configured for making one or more multifiber optical connections of opposing multifiber ferrules (e.g., MT ferrules). Multifiber VSFF components are distinguishable from more conventional multifiber small form factor (SFF) fiber optic interconnect components by their connection density. The dominant multifiber SFF fiber optic interconnect components are MPO components. The SN-MT connection system 10 depicted here is capable of approximately 2.7-times the connection density of standard MPO connection systems. Another multifiber VSFF connection system that may be known to those skilled in the art is the MMC connection system, available from US Conec Ltd., of Hickory, North Carolina.

This disclosure broadly pertains to prealignment features that may be used to improve the performance of multifiber VSFF connection systems and components (particularly, SN-MT, but also MMC and others). The principles of the present disclosure may also be adapted for use with multifiber SFF connection systems and components or future form factor multifiber connection systems and components.

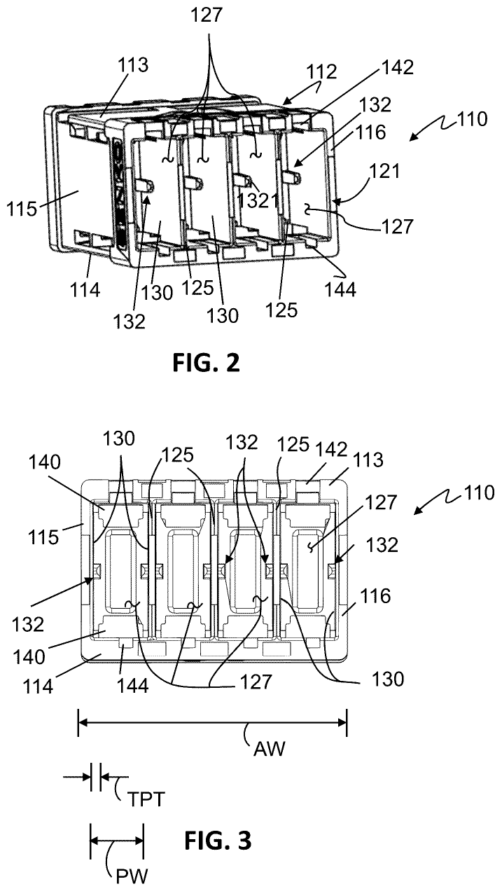

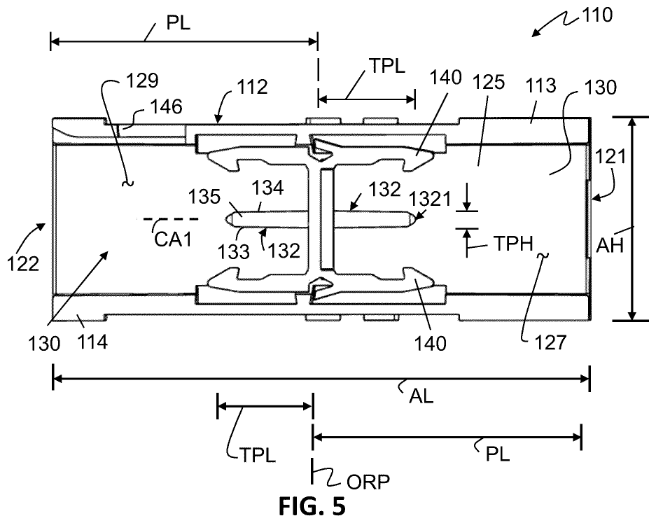

Referring to FIGS. 2-5, the SN-MT adapter 110 incorporating pre-alignment features in accordance with the present disclosure is shown in greater detail. The adapter 110 broadly comprises an adapter housing 112 having a first end portion, a second end portion, and a length AL extending along a longitudinal axis LA1 from the first end portion to the second end portion. The adapter housing 112 further comprises a top wall 113, a bottom wall 114, and a height AH extending from the top wall to the bottom wall. Additionally, the adapter housing comprises a first side wall 115, a second side wall 116, and a width AW (FIG. 3) extending from the first side wall to the second side wall. The adapter housing defines a first receptacle 121 adjacent the first end portion and a second receptacle 122 adjacent to the second end portion. The first and second receptacles 121, 122 meet at an optical reference plane ORP (FIG. 5) spaced apart lengthwise between the first end portion and the second end portion. Those skilled in the art will appreciate that the optical reference plane ORP is the plane in which fibers held by ferrules (not shown) mated with the first receptacle 121 interface with fibers held by ferrules (not shown) mated with the second receptacle 122.

Each of the first and second receptacles 121, 122 is configured to mate with a plurality of individual SN-MT connectors 210, 310. That is, each receptacle 121, 122 is a multiport receptacle. In the SN-MT adapter 110, partition walls 125 subdivide each receptacle 121, 122 into a plurality of individual connector ports 127, 129. In the illustrated adapter 110, each receptacle 121, 122 is a four-port receptacle. Hence, there are three partition walls 125 in each receptacle 121, 122, subdividing the receptacle into four respective individual connector ports 127, 129. In each receptacle, the individual connector ports 127, 129 are spaced apart along the width AW of the adapter. While the illustrated adapter 110 is a four-port adapter, it will be understood that other adapters in the scope of the present disclosure will have other numbers of ports in each receptacle. In fact, the prealignment principles of the present disclosure can be adapted for even single-port adapters and receptacles.

In the illustrated embodiment, each partition wall 125 extends along substantially the full length AL of the adapter 110 from the first end portion to the second end portion. In addition, each partition wall 125 extends along substantially the full height AH of the adapter 110 from the bottom wall 114 to the top wall 113. It is contemplated that, in certain embodiments, the partition wall may be formed from two separate wall segments in the first and second receptacles, respectively, separated by a gap or intervening structure. In each receptacle 121, 122, the first side wall 115, the second side wall 116, and the partition walls 125 define first and second interior sides 130 of each of the individual connector ports 127, 129.

Each port 127, 129 has a port length PL extending from the respective end portion of the adapter housing to the optical reference plane ORP and a port width PW extending between two opposing interior sides 130 of the port. Each interior side 130 is formed by either one of the side walls 115, 116 of the adapter housing 112 or one of the partition walls 125. The height of each port corresponds to the height AH of the adapter housing 112. In one or more embodiments, the port width PW is less than half the adapter height AH.

A prealignment feature 132 is formed on at least one interior side 130 of each of the connector ports 127, 129. Preferably, a prealignment feature 132 is formed on both interior sides 130 of each of the connector ports 127, 129. In the illustrated embodiment, along each partition wall 125, the prealignment feature 132 in the first receptacle 127 and the prealignment feature 132 in the second receptacle 129 are mirror images of one another on opposite sides of the optical reference plane ORP. The two opposing prealignment features 132 in each connector port 127, 129 are also mirror images of one another with respect to an imaginary plane running vertically and lengthwise at the center of the respective port width PW. As will be explained in further detail below, each prealignment feature 132 is configured to slidably engage a prealignment formation on a first side of a fiber optic connector 210, 310 as the fiber optic connector is inserted into the individual connector port 127, 129 to prealign a multifiber ferrule of the fiber optic connector in the adapter 110.

In the illustrated embodiment, each prealignment feature 132 comprises a tongue configured to be slidably received in a groove. Each tongue 132 has a leading end portion 1321 furthest from the optical reference plane ORP. The leading end portion 1321 of each tongue 132 is spaced apart lengthwise from the nearest end portion of the adapter housing 112 toward the optical reference plane ORP.

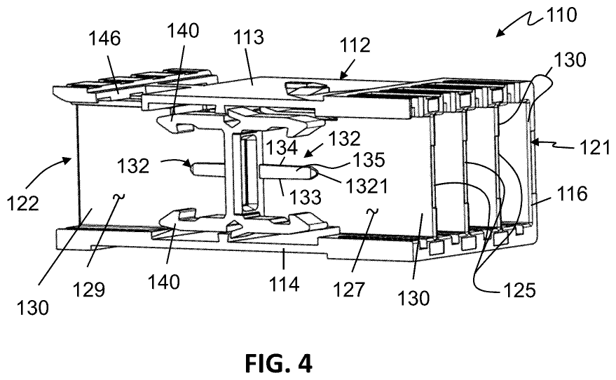

In the illustrated embodiment, each tongue has three sides: a bottom side 133, a top side 134, and an inner side 135 (see FIGS. 4 and 5). Preferably, the leading end portion 1321 of each tongue 132 is chamfered on at least one of the three sides 133, 134, 135. In the illustrated embodiment, the leading end portion 1321 of each tongue 132 is chamfered on all three sides 133, 134, 135.

Each tongue 132 has a length TPL (FIG. 5) extending from the leading end portion 1321 to an opposite end portion at or adjacent to the optical reference plane ORP. Each tongue 132 also has a height TPH extending from the bottom side 133 to the top side 134 and a thickness TPT (FIG. 3) extending from the respective interior side 130 of the port 127, 129 to the inner side 135 of the tongue. Each tongue 132 is tapered lengthwise such that the height TPH increases as the tongue extends inboard lengthwise from the leading end portion 1321 toward the opposite end portion. Each tongue 132 may also be tapered lengthwise such that the thickness TPT increases as the tongue extends inboard lengthwise from the leading end portion 1321 toward the opposite end portion. In certain embodiments, the tongue length TPL is less than half the port length PL. In some embodiments, the maximum tongue height TPH is less than one-sixth of the adapter height AH. In an embodiment, the maximum tongue thickness TPT is less than one-fourth the port width PW. In the illustrated embodiment, the tongues 132 are centered along the adapter height AH.

As explained above, the illustrated adapter 110 is an SN-MT adapter. Hence, the illustrated SN-MT adapter 110 comprises SN-MT interface and latching features, including opposing latch arms 140 in each of the individual connector ports 127 of the first receptacle 121 and each of the individual connector ports 129 of the second connector 122. The latch arms 140 extend alongside the top wall 113 and the bottom wall 114. Additionally, the top wall 113 and the bottom wall 114 define polarity keyways 142, 144 in each of the individual connector ports 127, 129. In the illustrated embodiment, the second receptacle 122 of the SN-MT adapter 110 is configured for mating with behind-the-wall SN-MT connectors. Hence, the top wall 113 comprises a recessed latch keeper 146 in each individual connector port 129 of the second receptacle 122, but the top wall is devoid of recessed latch keepers in the first receptacle 121.

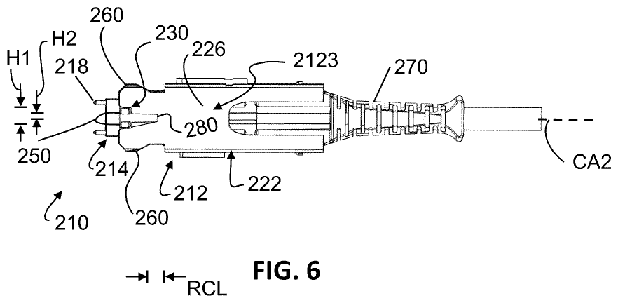

Referring now to FIGS. 6-8, the connector 210 of connection system 10 is a full-featured SN-MT connector. The connector 210 comprises a connector housing assembly 212 with a top portion 2121, a bottom portion 2122, and a height CH extending from the top portion to the bottom portion. The connector housing assembly 212 also has first and second side walls 2123 and a width CW extending from the first side wall to the second side wall. In the illustrated embodiment, the height CH is at least double the width CW.

The connector housing assembly 212 is configured to retain and house a multifiber MT ferrule 214. The multifiber ferrule 214 has a fiber alignment axis FA and first and second guide pin openings 216 spaced apart along the fiber alignment axis. In the illustrated embodiment, a guide pin 218 is retained in each guide pin opening 216. Thus, in the illustrated example, the ferrule 214 has a male configuration. The connector housing assembly 212 may also hold a female ferrule 214 (with empty guide pin openings 216) or a hermaphroditic ferrule 214 (with one empty guide pin opening 216 and a guide pin 218 retained in the other guide pin opening). Regardless of gender, the multifiber ferrule 214 is received in the connector housing assembly 212 such that the fiber alignment axis FA extends heightwise. As is known by those skilled in the art, the multifiber ferrule 214 is configured to terminate a plurality of optical fibers such that the optical fibers are exposed through fiber openings in an end face 215 of the ferrule. Typically, the fiber openings are arranged in one or more rows of at least eight fibers, where each row extends parallel to the fiber alignment axis FA.

The connector housing assembly 212 comprises a prealignment formation 230 formed in at least one of the side walls 2123 of the housing assembly. In the illustrated and preferred embodiment, the connector housing assembly 212 comprises prealignment formations 230 in each of the first side wall 2123 and the second side wall 2123. In the illustrated embodiment, each prealignment formation 230 comprises a prealignment groove having an open front end into which the tongue 132 on an interior side 130 of an individual connector port 127, 129 of the mating adapter 110 is passable as the fiber optic connector 210 is plugged into the mating adapter. As will be explained in further detail below, the side wall 2123 of the connector housing assembly 212 engages with the tongue 132 to prealign the multifiber ferrule 212 with the mating adapter 110 for making an optical connection to another multifiber ferrule in the adapter without guide pin stubbing.

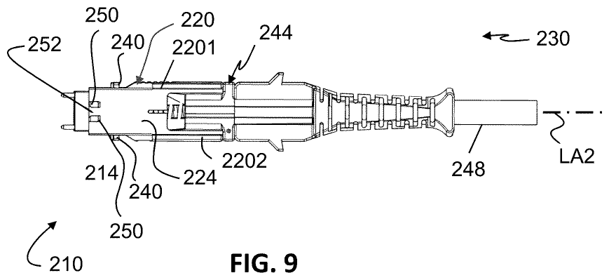

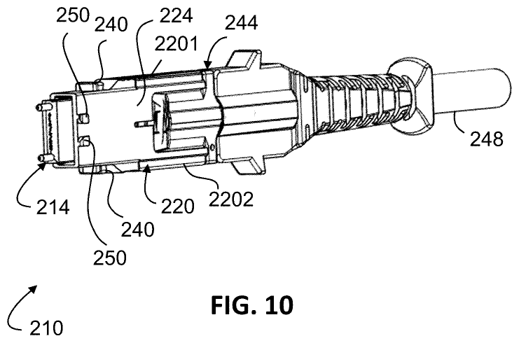

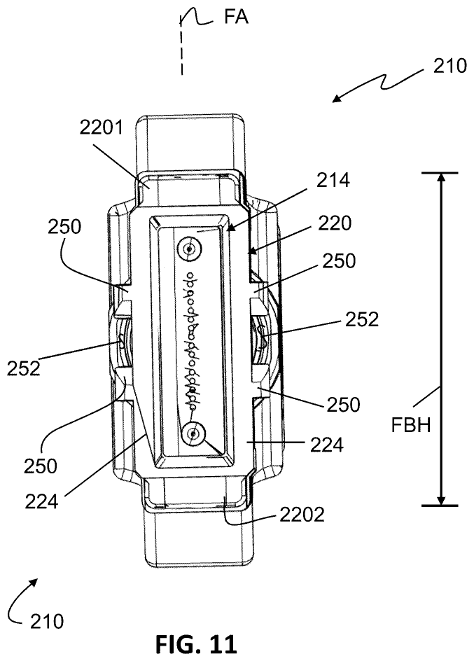

The illustrated connector 210 is an SN-MT connector. Hence, the connector housing assembly 212 is made up of two nested housing components. First, the connector housing assembly 212 comprises a front body 220 that directly holds the multifiber ferrule 214. Second, the connector housing assembly 212 comprises an outer housing 222 surrounding the front body 214. As shown in FIGS. 9-13. the front body 220 has first and second side walls 224 forming portions of the first and second side walls 2123 of the connector housing assembly 212, respectively. And likewise as shown in FIGS. 6-8, the outer housing 222 has first and second side walls 226 forming portions of the first and second side walls 2123 of the connector housing assembly, respectively. In the illustrated embodiment, as explained more fully below, the front body 220 and the outer housing 222 define respective portions of the prealignment grooves 230 on both side walls of the connector housing assembly 212.

Referring to FIGS. 9-13, an exemplary embodiment of the front body 220 will now be described in greater detail. The front body 220 has a front end and a rear end spaced apart along a longitudinal axis LA2 of the connector 210. The front body 220 further has top portion 2201, a bottom portion 2202, and a height FBH extending from the bottom portion to the top portion. The height FBH runs parallel to the fiber alignment axis FA. The top portion 2201 and the bottom portion 2202 of the front housing 220 respectively define keepers 240 configured to latch with the opposing latch arms 140 (FIG. 5) in the mating receptacles 127, 129. The first and second side walls 224 of the front body 220 extend heightwise from the bottom portion 2202 to the top portion 2201 on opposite sides of the multifiber ferrule 214.

Typical of an SN-MT connector 210, the rear end portion of the front body 220 is configured to couple to a back body 244, and the back body is configured to load a ferrule spring 246 against the multifiber ferrule 214 to yieldably bias the ferrule forward in relation to the front body 220. In the illustrated embodiment, a combined crimp ring and heat shrink tube 248 is secured to a back post portion (not shown) of the back body 244.

In general, a front body in the scope of the present disclosure may have a prealignment formation on at least one of the two side walls. In the illustrated embodiment, the front body 220 comprises prealignment formations on both side walls 224 in the form of first and second projections 250 spaced apart heightwise to define a prealignment groove segment 252 (more broadly, a prealignment groove) therebetween. The prealignment groove segment 252 forms a front portion of the prealignment groove 230 on the respective side wall 2123 of the connector housing assembly 212.

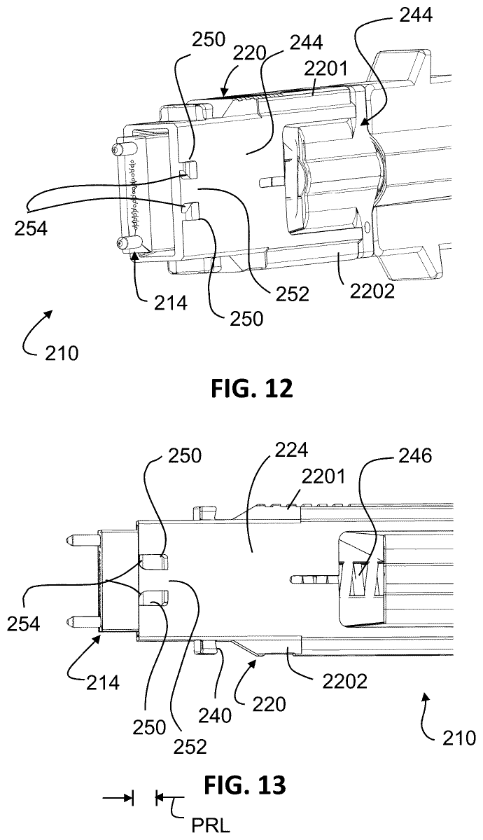

The first and second projections 250 are located at the front end of the front body 220. For example, the first and second projections 250 have front end at the front end of the front body 220 (e.g., the ends of the projections 250 are coplanar with the ends of the front body 220). Each projection 250 also has an inner side defining the top or bottom of the respective prealignment groove segment 252. Between the respective front end and the respective inner side, each illustrated projection 250 has a chamfered corner 254 (FIGS. 12 and 13). The chamfered corners 254 of the projections 250 and the chamfered leading end portion 1321 of the tongues 132 on the inner sides 130 of the connector ports 127, 129 help guide the tongues (of the adapter 110) into the prealignment groove segments 252 as the connector 210 is plugged into the adapter 110. The combined effect of the chamfered leading end portion 1321 1321 of the tongues 132 and the chamfered corners 254 is that the tongues will self-center in the prealignment grooves 250 as the chamfered leading end portion 1321 enters the prealignment groove 130.

In the illustrated embodiment, each of the projections 250 is relatively short in length. For example, each projection 250 can have a length PRL (FIG. 13) along the longitudinal axis LA2 that is less than one-third the length TL of the tongue 132. The length of the projections on the connector can vary from what is shown without departing from the scope of the disclosure.

Referring again to FIGS. 6-9, an exemplary embodiment of the outer housing 222 will now be described in greater detail. The outer housing 222 has a front end portion and a rear end portion spaced apart along the longitudinal axis LA. The outer housing 222 further has top portion 2221 and a bottom portion 2222 spaced apart along the height CH of the connector housing assembly 212. First and second side walls 224 of the front body 220 extend heightwise from the bottom portion 2222 to the top portion 2221 on opposite sides of the multifiber ferrule 214.

The top portion 2221 and the bottom portion 2222 of the outer housing 222 respectively define ramp surfaces 260 that are configured to lift the opposing latch arms 140 as the connector 210 is inserted into and extracted from the mating receptacles 127, 129. In addition, the top portion 2221 and the bottom portion 2221 of the outer housing 222 comprise polarity keys 290, 292 that are configured to slide into the keyways 142, 144 of the adapter 110 when the connector 210 is inserted in the correct orientation. Conversely, the polarity keys 290, 292 will block insertion of the connector 210 into the adapter 110 when an attempt is made to plug the connector in upside down.

Again, the illustrated connector 210 is an SN-MT connector. The SN-MT connector is configured to unlatch the latch arms 140 from the keepers 240 of the front body 220 by displacing the outer housing 222 rearward in relation to the outer housing. Thus, in the illustrated embodiment, the outer housing 222 is displaceable rearward in relation to the front body 20 for extracting the fiber optic connector 210 from the mating adapter 110. The illustrated connector 210 comprises a push-pull boot 270 coupled to the rear end portion of the outer housing 222 such that the outer housing can be displaced in relation to the front body 220 by pulling rearward on the push-pull boot. The connector 210 can also be inserted into the mating receptacle 121, 122 by pushing forward on the push-pull boot 270.

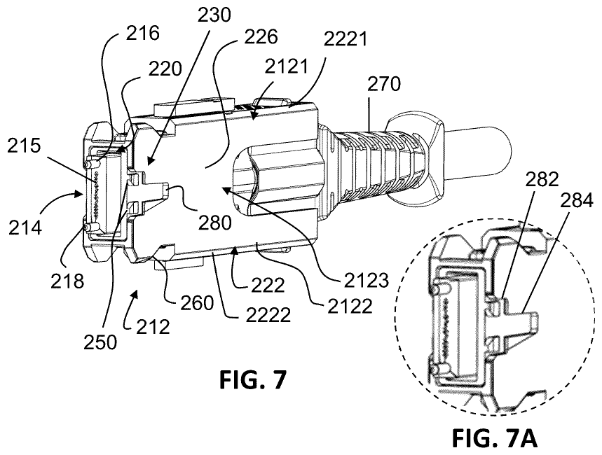

The side walls 226 of the outer housing define cutouts 280 exposing the projections 250 formed on the side walls 224 of the front body 220. Each cutout 280 has a front segment 282 (FIG. 7A) containing the projections 250 and a rear segment 284 (FIG. 7A) rearward of the projections 250. The front segment 282 has a first height H1 (FIG. 6), and the rear segment 284 has a second height H2 less than the first height. Each rear segment 284 forms a rear portion of the respective prealignment groove 230 in which a portion of the tongue 132 is received when the connector 210 is plugged into the adapter 110. The rear segment 284 has a length RCL that is greater than the length of the projections 250 on the front body 22. Thus, in the illustrated embodiment, the cutouts 280 define a greater extent of the prealignment grooves 230 than the projections 250.

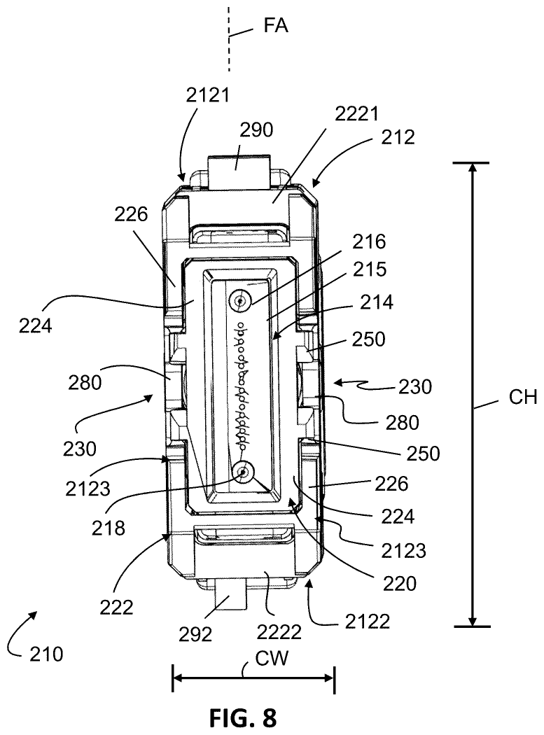

Referring to FIG. 8, it can be seen that the projections 250, though exposed in the cutouts 280, do not protrude widthwise beyond the planar side walls 226 of the outer housing 222.

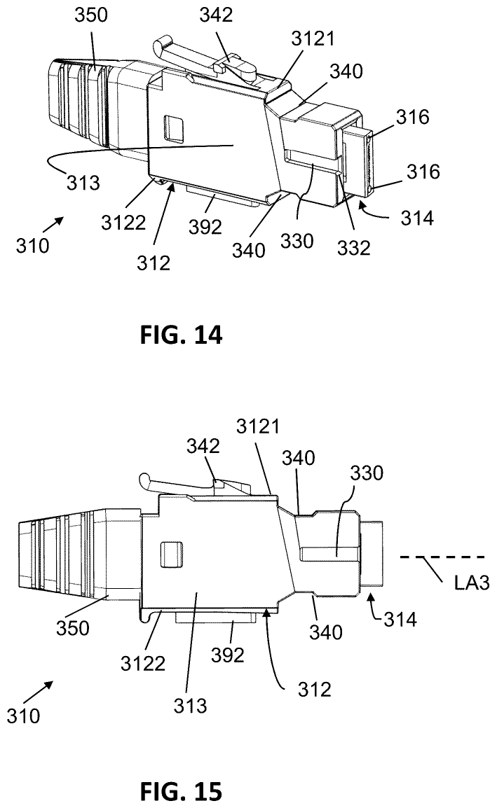

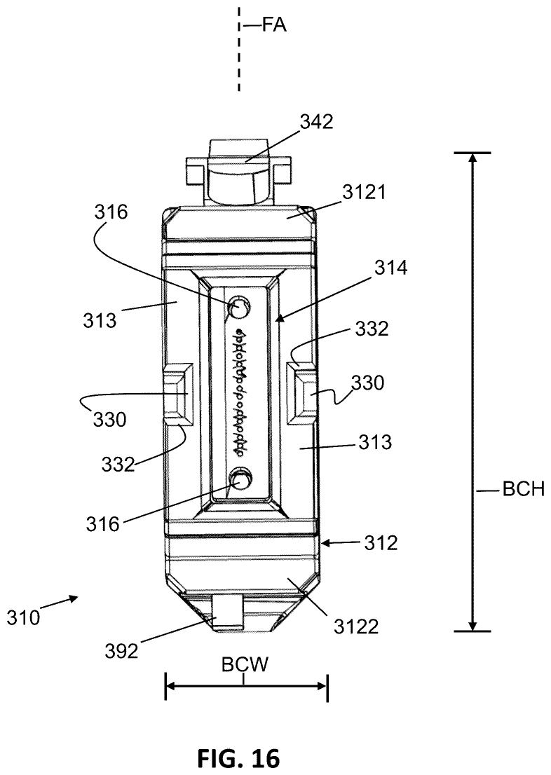

Referring to FIGS. 14-16, the connector 310 is a behind-the-wall connector that has a shorter overall length along its longitudinal axis LA3 than the connector 210. The connector 310 comprises a one-piece connector housing 312 having a top portion 3121, a bottom portion 3122, and a height BCH extending from the bottom portion to the top portion. The one-piece connector housing 312 further comprises first and second side walls 313 and a width BCW extending from the first side wall to the second side wall. The height BCH is at least double the width BCW.

The connector 310 holds a multifiber ferrule 314 having a fiber alignment axis FA and first and second guide pin openings 316 spaced apart along the fiber alignment axis. The multifiber ferrule 314 is received in the connector housing assembly 312 such that the fiber alignment axis FA extends heightwise. In the illustrated embodiment, the ferrule 314 has a female configuration, in which the two guide pin openings are empty. But it will be understood that the ferrule 314 could also have a male or hermaphroditic configuration without departing from the scope of the disclosure.

A prealignment groove 330 is formed in each of the first and second side walls 313 of the connector housing 312. Each prealignment groove 330 has an open front end into which the tongue 132 on the interior side 130 of an individual connector port 129 of the adapter 110 is passable as the fiber optic connector 310 is plugged into the adapter. The guide grooves 330 do not penetrate the full thickness of the side walls 313 of the connector housing 312. In the illustrated embodiment, there are slight chamfers 332 on the front corners of the prealignment grooves 330 to aid in guiding the leading end portion 1321 of the tongues 132 into the grooves. By slidably receiving the tongues 132 of the adapter 110 in the prealignment grooves 330, the connector 310 prealigns itself with the adapter for making an optical connection to another multifiber ferrule in the adapter without guide pin stubbing.

In the illustrated embodiment, the top and bottom portions of the connector housing 312 comprise latch detent recesses 340. The latch detent recesses 340 are configured to receive the opposing adapter latch hooks 142 of the adapter 110 when the connector 310 is mated with the adapter. However, the latch hooks 142 do not securely latch to the connector 310 when engaged with the recesses 340. Instead, the connector housing 312 comprises a depressible adapter latch 342 on the top portion 3121. The adapter latch 312 is configured to latch with the latch keeper recess 146 (FIG. 4) to releasably retain the connector 310 in the adapter 110.

In the illustrated embodiment, the connector 310 further comprises a strain relief boot 350. The strain relief boot 350 is configured to couple to the rear end portion of the connector housing 312 to load a ferrule spring 352 (FIG. 24) against the ferrule 314 such that the ferrule is yieldably biased forward in the connector housing.

The connector housing 312 further comprises a polarity key 392 on the bottom portion of the connector housing. The polarity key 392 is configured to be slidably received in the keyway 144 on the bottom wall 114 of the adapter housing 112 when the connector 310 is plugged into the adapter 110.

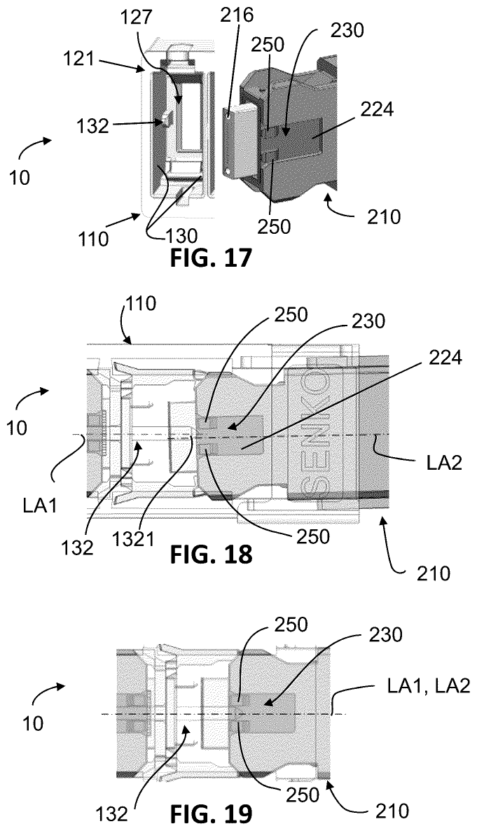

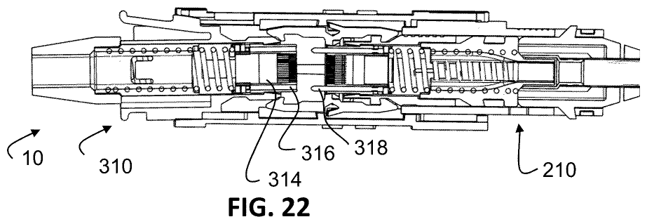

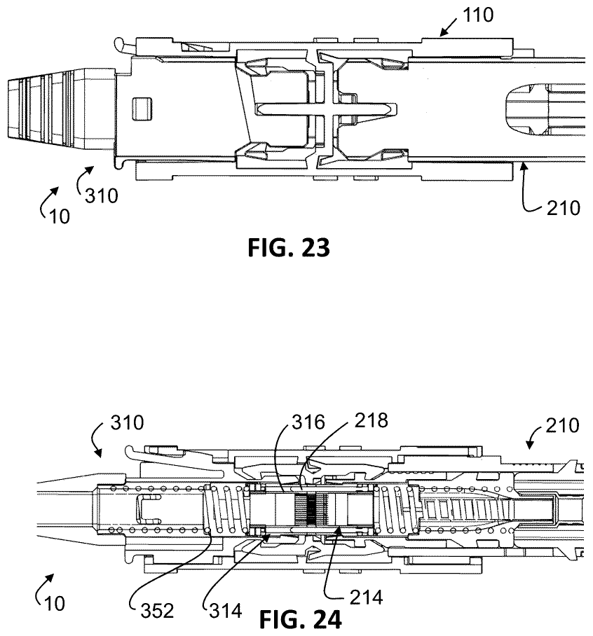

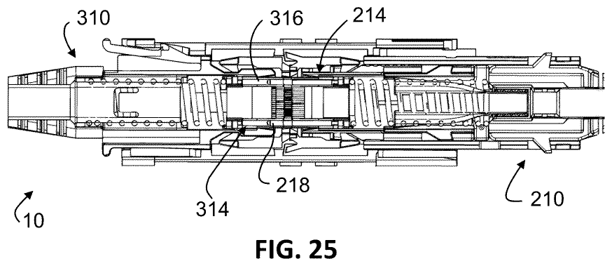

Referring to FIGS. 17-25, the connection system 10 is broadly configured to facilitate connections of two multifiber connectors 210, 310 without guide pin stubbing.

As shown in FIGS. 17-19, when the fiber optic connector 210 is inserted into the connector port 127 of the receptacle 121, initially the connector is coarsely guided into alignment with the connector port by the four walls defining the top, bottom, and opposing sides of the connector port. But as shown in FIG. 18, there is sufficient play between the connector housing assembly 212 and the connector port 127 to allow the connector 210 to advance along the port at a skewed orientation where the longitudinal axis LA2 of the connector 210 is skewed with respect to the longitudinal axis LA1 of the adapter 110. Uncorrected, this skew would cause guide pin stubbing when the ferrule 214 meets the opposing ferrule within the adapter 110. However, the prealignment features on the adapter 110 discussed above and the prealignment formations on the connector 210 described above are configured to correct the skew and reorient the connector 210 so that the longitudinal axis LA2 is parallel with and in heightwise alignment with the longitudinal axis LA1 before the ferrule 214 meets the opposing ferrule, thereby preventing stubbing.

More particularly, as the connector 210 advances along the port 127, the chamfers 254 of the projections 250 engage the chamfered leading end portion 1321 of the tongues 132 to guide the leading end portion 1321 of the tongues 132 into the prealignment grooves 230. The projections 250 on the side walls 224 of the front body 220 slidably engage the tongues 132 to further align the axis LA2 of the connector with the axis LA1 of the adapter. The tongues 132 are thus slidably received in the prealignment grooves 230 on the side walls 2123 of the connector housing assembly 212 to prealign the multifiber ferrule 214 of the fiber optic connector in relation to the opposing multifiber ferrule for making a multifiber optical connection between the multifiber ferrule of the fiber optic connector and the other multifiber ferrule. Thus, reception of the tongues 132 in the prealignment grooves 230 prealigns the ferrule 214 with the adapter to prevent guide pin stubbing.

In FIGS. 17-19, the multifiber ferrule 214 is a female multifiber ferrule comprising empty guide pin openings 216 and the other multifiber ferrule in the adapter 110 is a male multifiber ferrule having guide pins 218. The prealignment projections 250 on the side walls 224 of the front body 220 slidably engage the tongues 132 as the fiber optic connector 210 is inserted into the mating receptacle to prealign the female multifiber ferrule 214 with the male multifiber ferrule such that the empty guide pin openings 216 mate with the guide pins 218 without the guide pins stubbing the end face of the female multifiber ferrule. When the two guide pins of the male ferrule are received in the empty guide pin openings 216 of the female ferrule 214, the guide pin fit precisely aligns the optical fibers in the two ferrules so that a multifiber optical connection is made.

In an alternative example, the multifiber ferrule 214 is a male multifiber ferrule comprising guide pins 218 retained in the first and second guide pin openings 216 and the multifiber ferrule in the adapter is a female multifiber ferrule with empty guide pin openings. In this example, the projections 250 on at least the side walls 224 of the front body 220 slidably engage the tongues 132 in the adapter 110 as the fiber optic connector is inserted to prealign the male multifiber ferrule 214 with the female multifiber ferrule such that the guide pins 218 mate with the empty guide pin openings without stubbing an end face of the female multifiber ferrule.

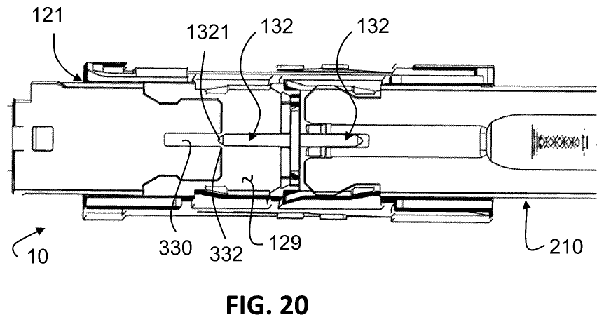

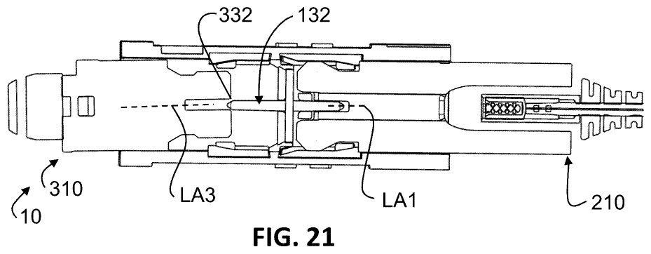

As shown in FIGS. 20-25, when the behind-the-wall fiber optic connector 310 is inserted into the connector port 129 of the receptacle 122, initially the connector is coarsely guided into alignment with the connector port by the four walls defining the top, bottom, and opposing sides of the connector port. But as shown in FIG. 21, again there is sufficient play between the connector housing 312 and the connector port 129 to allow the connector 310 to advance along the port at a skewed orientation where the longitudinal axis LA3 of the connector 310 is skewed with respect to the longitudinal axis LA1 of the adapter 110. The prealignment features inside the adapter 110 and the prealignment features on the connector 310 are configured to correct the skew and reorient the connector 310 so that the longitudinal axis LA3 is parallel with and in heightwise alignment with the longitudinal axis LA1 before the ferrule 314 meets the opposing ferrule 214, thereby preventing guide pin stubbing.

More particularly, as the connector 310 advances along the port 129, the chamfers 332 engage the chamfered leading end portion 1321 of the tongues 132 to guide the leading end portion of the tongues 132 into the prealignment grooves 330. The tongues 132 slide along grooves 330 to further align the axis LA3 of the connector 310 with the axis LA1 of the adapter. Thus, reception of the tongues 132 in the prealignment grooves 230 prealigns the ferrule 314 with the adapter to prevent the guide pins 218 of opposing connector 210 from stubbing on the end face of the ferrule 314.

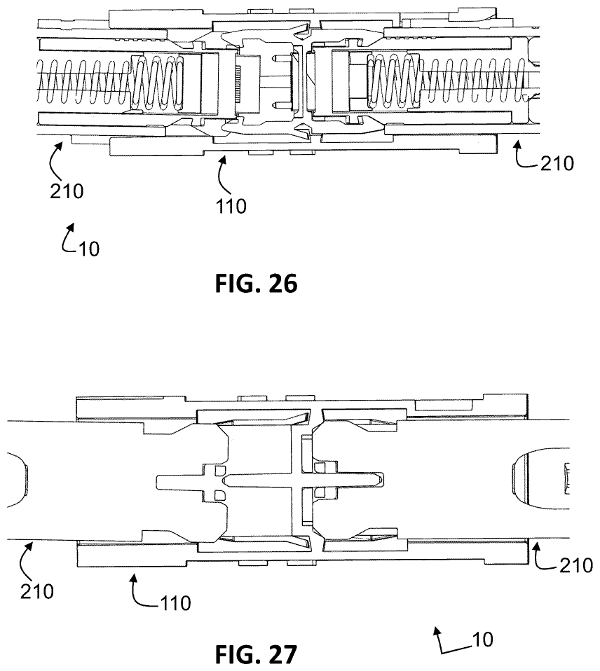

Referring to FIGS. 26 and 27, in another embodiment, a connection system 10 comprises an adapter 110 mated with two connectors 210. Both connectors 210 are prealigned in the adapter 110 using the prealignment features described above.

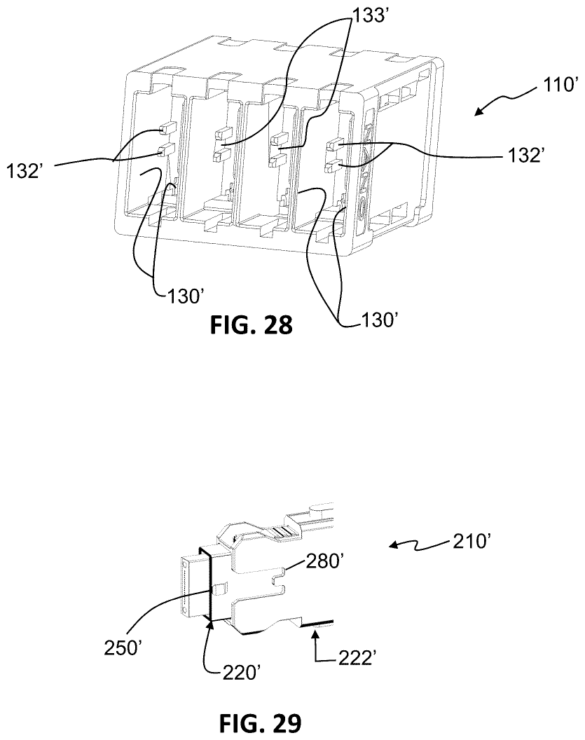

Referring to FIG. 28, an alternative embodiment of an adapter in the scope of the present disclosure is generally indicated at reference number 110′, and referring to FIG. 29, an alternative embodiment of a connector in the scope of the present disclosure is generally indicated at reference number 210′. The adapter 110′ and connector 210′ operate similar to the adapter 110 and the connector 210, except that the prealignment features/formations on the adapter and connector are reversed. Parts of adapter 110′ that correspond with parts of the adapter 110 are given the same reference number, followed by a prime symbol. Likewise, parts of connector 210′ that correspond with parts of connector 210′ are given the same reference number, followed by a prime symbol.

Whereas the connector 210 comprises a prealignment groove 230 formed in part by two projections 250 on the inner front body 220, here, two projections 132′ are formed on the inner side walls 130′ of adapter 110′ at locations spaced apart heightwise to define prealignment grooves 133′. And whereas the adapter 110 comprises tongues 232 configured to be slidably received in the prealignment grooves 230 of the connector 210, here the inner front body 220′ of the connector 210′ comprises tongues 250′ (broadly, a prealignment formation) configured to be slidably received in the prealignment grooves 133′ of the adapter 110′. The cutouts 280′ on the outer housing 222′ are enlarged in relation to the cutouts 280 to accommodate the projections 132′ in the cutouts 280′ when the connector 210′ is mated with the adapter 110′.

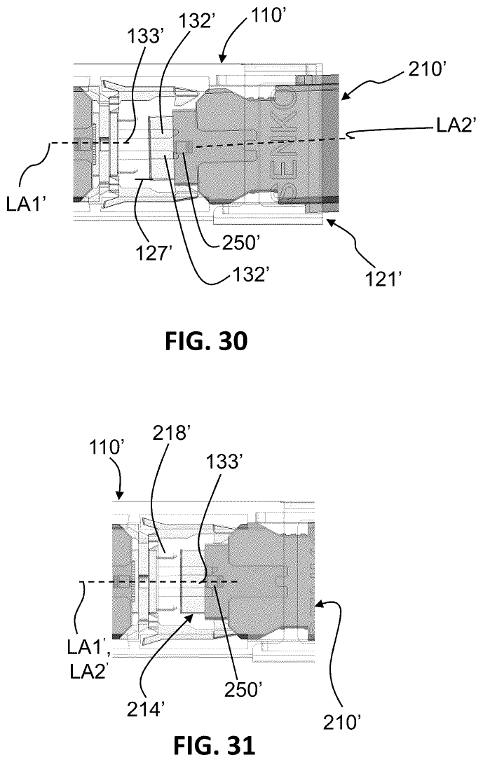

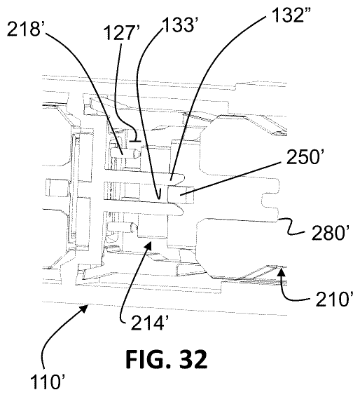

As shown in FIGS. 30-32, when the fiber optic connector 210′ is inserted into the connector port 127′ of the receptacle 121′, initially the connector is coarsely guided into alignment with the connector port by the four walls defining the top, bottom, and opposing sides of the connector port. But as shown in FIG. 30, there is sufficient play between the connector housing assembly 212′ and the connector port 127′ to allow the connector 210 to advance along the port at a skewed orientation where the longitudinal axis LA2′ of the connector 210′ is skewed with respect to the longitudinal axis LA1′ of the adapter 110. The prealignment features inside the adapter 110′ and the prealignment features on the connector 210′ are configured to correct the skew and reorient the connector 210′ so that the longitudinal axis LA2′ is parallel with and in heightwise alignment with the longitudinal axis LA1′ before the ferrule 214′ meets the opposing ferrule, thereby preventing guide pin stubbing.

More particularly, as the connector 210′ advances along the port 127′, the tongue 250′ enters the prealignment groove 133′ and begins to slide along the prealignment groove to align the axis LA2′ of the connector 210′ with the axis LA1′ of the adapter 110′. Reception of the tongues 250′ in the prealignment grooves 130′ prealigns the ferrule 214′ with the adapter 110′ to prevent the guide pins 218 guide pin of opposing connector from stubbing on the end face of the ferrule 214′. As the connector 210′ advances, the projections 132′ are received in the cutouts 280′.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A fiber optic connector comprising:
a multifiber ferrule having a fiber alignment axis and first and second guide pin openings spaced apart along the fiber alignment axis;
a front body for holding the multifiber ferrule, the front body having height extending parallel to the fiber alignment axis and first and second side walls extending heightwise on opposite sides of the multifiber ferrule, the front body comprising a prealignment formation on at least the first side wall; and
an outer housing surrounding the front body, the outer housing comprising first and second side walls extending heightwise on opposite sides of the front body, at least the first side wall of the outer housing defining a cutout exposing the prealignment formation on the first side wall of the front body;
wherein the fiber optic connector is configured to be inserted into a mating receptacle and wherein the prealignment formation on at least the first side wall of the front body is configured to slidably engage a prealignment feature on a wall of the mating receptacle as the fiber optic connector is inserted into the mating receptacle to prealign the multifiber ferrule of the fiber optic connector along the fiber optic alignment axis in relation to said another multifiber ferrule for making a multifiber optical connection between the multifiber ferrule of the fiber optic connector and said another multifiber ferrule.

2. The fiber optic connector of claim 1, in combination with said another multifiber ferrule, wherein the multifiber ferrule is a male multifiber ferrule comprising guide pins retained in the first and second guide pin openings and wherein said another multifiber ferrule is a female multifiber ferrule having empty guide pin openings, the prealignment formation on at least the first side wall of the front body configured to slidably engage the prealignment feature on the wall of the mating receptacle as the fiber optic connector is inserted into the mating receptacle to prealign the male multifiber ferrule with the female multifiber ferrule such that the guide pins mate with the empty guide pin openings without stubbing an end face of the female multifiber ferrule.

3. The fiber optic connector of claim 1, in combination with said another multifiber ferrule, wherein the multifiber ferrule is a female multifiber ferrule comprising empty guide pin openings and an end face and wherein said another multifiber ferrule is a male multifiber ferrule having guide pins, the prealignment formation on at least the first side wall of the front body configured to slidably engage the prealignment feature on the wall of the mating receptacle as the fiber optic connector is inserted into the mating receptacle to prealign the female multifiber ferrule with the male multifiber ferrule such that the empty guide pin openings mate with the guide pins without the guide pins stubbing the end face of the female multifiber ferrule.

4. The fiber optic connector of claim 1, wherein the front body further comprises a prealignment formation on the second side wall and wherein the second side wall of the outer housing defines a cutout exposing the prealignment formation on the second side wall of the outer housing.

5. The fiber optic connector of claim 4, wherein each of the prealignment formation on the first side wall and the prealignment formation on the second side wall comprises first and second projections spaced apart heightwise to define a prealignment groove therebetween.

6. The fiber optic connector of claim 1, wherein the prealignment formation on the first side wall comprises first and second projections spaced apart heightwise to define a prealignment groove therebetween.

7. The fiber optic connector of claim 1, wherein the cutout has a front segment containing the prealignment formation and a rear segment rearward of the prealignment formation, the front segment having a first height and the rear segment having a second height less than the first height.

8. The fiber optic connector of claim 1, wherein the outer housing is displaceable in relation to the front body for unlatching the fiber optic connector from the mating receptacle.

9. A fiber optic adapter comprising:
an adapter housing having a first end portion, a second end portion, a top wall, a bottom wall, a first side wall, a second side wall, a length extending from the first end portion to the second end portion, a height extending from the top wall to the bottom wall, and a width extending from the first side wall to the second side wall, the adapter housing defining a first receptacle adjacent the first end and a second receptacle adjacent to the second end portion, the first and second receptacles meeting at an optical reference plane spaced apart lengthwise between the first end portion and the second end portion;
at least one partition wall in the first receptacle, the at least one partition wall subdividing the first receptacle into a plurality of individual connector ports, the individual connector ports being spaced apart widthwise along the first receptacle, the first side wall, the second side wall, and the at least one partition wall defining first and second interior sides of each of the individual connector ports; and
a prealignment feature formed on at least the first interior side of each of the connector ports, each prealignment feature configured to slidably engage a prealignment formation on a first side of a fiber optic connector as the fiber optic connector is inserted into the individual connector port to prealign a multifiber ferrule of the fiber optic connector in the adapter.

10. The fiber optic adapter as set forth in claim 9, wherein each prealignment feature comprises a tongue configured to be slidably received in a guide groove formed in the first side of the fiber optic connector.

11. The fiber optic adapter as set forth in claim 10, wherein the tongue has a leading end portion and wherein the leading end portion is spaced apart lengthwise from the first end portion of the adapter housing toward the optical reference plane.

12. The fiber optic adapter as set forth in claim 9, further comprising a prealignment feature formed on the second side of each of the individual connector ports.

13. The fiber optic adapter as set forth in claim 9, further comprising:
at least one partition wall in the second receptacle, the at least one partition wall in the second receptacle subdividing the second receptacle into a plurality of individual connector ports, the individual connector ports of the second receptacle being spaced apart widthwise, the first side wall, the second side wall, and the at least one partition wall of the second receptacle defining first and second interior sides of each of the individual connector ports of the second receptacle; and
a prealignment feature formed on at least the first interior side of each of the connector ports of the second receptacle, each prealignment feature of the second receptacle configured to slidably engage a prealignment formation on a first side of a fiber optic connector as the fiber optic connector is inserted into the individual connector port of the second receptacle to prealign a multifiber ferrule of the fiber optic connector in the adapter.

14. The fiber optic adapter as set forth in claim 13, wherein the fiber optic adapter is an SN-MT adapter comprising opposing latch arms in each of the individual connector ports of the first receptacle and each of the individual connector ports of the second connector alongside the top wall and the bottom wall.

15. The fiber optic adapter as set forth in claim 14, wherein the top wall comprises a recessed latch keeper in each individual connector port of the second receptacle and is devoid of recessed latch keepers in the first receptacle.

16. A fiber optic connector comprising:
a connector housing assembly having a top portion, a bottom portion, a first side wall, a second side wall, a height extending from the bottom portion to the top portion, and a width extending from the first side wall to the second side wall, the height being at least double the width;
a multifiber ferrule having a fiber alignment axis and first and second guide pin openings spaced apart along the fiber alignment axis, the multifiber ferrule received in the connector housing assembly such that the fiber alignment axis extends heightwise; and
a prealignment groove formed in the first side wall and the second side wall of the connector housing assembly, each prealignment groove having an open front end into which a prealignment projection on an interior side of a mating adapter is passable as the fiber optic connector is plugged into the mating adapter, whereby the side wall of the connector housing assembly engages with the prealignment projection to prealign the multifiber ferrule with the mating adapter for making an optical connection to another multifiber ferrule in the mating adapter without guide pin stubbing.

17. The fiber optic connector of claim 16, wherein the connector housing assembly comprises a front body and an outer housing surrounding the front body, the front body having first and second side walls forming portions of the first and second side walls of the connector housing assembly, respectively, the outer housing having first and second side walls forming portions of the first and second side walls of the connector housing assembly, respectively, the front body comprising first and second projections on the first side wall thereof and first and second projections on the second side wall thereof, the first and second projections on the first and second side walls respectively defining front portions of the prealignment grooves, the first and second side walls of the outer housing defining cutouts having front segments for receiving the respective first and second projections and rear segments defining rear portions of the prealignment grooves.

18. The fiber optic connector of claim 16, wherein the connector is a behind-the-wall connector and the connector assembly is a one-piece connector housing assembly.

19. The fiber optic connector of claim 18, wherein the connector housing assembly further comprises a latch detent recess formed in the top portion and a second latch detent recess formed in the bottom portion, the first and second latch detent recesses configured to receive opposing adapter latch hooks of the mating adapter.

20. The fiber optic connector of claim 19, wherein the connector housing assembly further comprises a depressible adapter latch on the top portion, the adapter latch configured to latch with a latch keeper recess of the mating adapter to releasably retain the fiber optic connector in the mating adapter.
